(19) United States
(12) Patent Application Publication
(10) Pub. No.: US 2020/0097019 A1
(43) Pub. Date: Mar. 26, 2020

(54) VISION SYSTEM FOR AN AUTOMOTIVE VEHICLE

(71) Applicant: GM GLOBAL TECHNOLOGY OPERATIONS LLC, Detroit, MI (US)

(72) Inventors: Hao Yu, Troy, MI (US); Wende Zhang, Troy (US); Brian J. Hufnagel, Brighton, MI (US)

(21) Appl. No.: 16/142,150

(22) Filed: Sep. 26, 2018

(51) Int. Cl. G05D 1/02; G05D 1/00; G06K 9/00; G06T 7/73

(52) U.S. Cl. CPC G05D 1/0246; G05D 1/0088; G06T 2207/30261; G06T 7/74; G05D 2201/0213; G06K 9/00805

(57) ABSTRACT

An automotive vehicle includes an actuator configured to control vehicle steering, acceleration, speed, or shifting, a sensor configured to capture images of a region exterior to the vehicle, an illumination device coupled to the vehicle, and a controller in communication with the actuator, the sensor, and the illumination device. The controller is configured to, during a drive cycle, control the sensor to capture a first image with the illumination device emitting light and a second image with the illumination device not emitting light. The controller is additionally configured to calculate a difference image between the first image and the second image. The controller is further configured to control the actuator in a first mode in response to an object being detected in the difference image, and to control the actuator in a second mode in response to no object being detected in the difference image.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels. Operation of such vehicles is facilitated by high-fidelity sensor readings with a minimal amount of noise.

### SUMMARY

An automotive vehicle according to the present disclosure includes an actuator configured to control vehicle steering, acceleration, speed, or shifting, a sensor configured to capture images of a region exterior to the vehicle, an illumination device coupled to the vehicle, and a controller in communication with the actuator, the sensor, and the illumination device. The controller is configured to, during a drive cycle, control the sensor to capture a first image with the illumination device emitting light and a second image with the illumination device not emitting light. The controller is additionally configured to calculate a difference image between the first image and the second image. The controller is further configured to control the actuator in a first mode in response to an object being detected in the difference image, and to control the actuator in a second mode in response to no object being detected in the difference image.

In an exemplary embodiment, the controller is further configured to detect interference in the difference image and, in response to detecting interference, to change a coding scheme of the illumination device. In such embodiments, the first image may be a first composite image comprising a plurality of images captured with the illumination device emitting light, and the second image may be a second composite image comprising a plurality of images captured with the illumination device not emitting light.

In an exemplary embodiment, the first mode comprises a projection of structured light on the identified object. In such embodiments, the structured light may be projected via the illumination device.

In an exemplary embodiment, the illumination device comprises at least one LED.

A method of controlling a vehicle according to the present disclosure includes providing the vehicle with an actuator configured to control vehicle steering, acceleration, speed, or shifting, a sensor configured to capture images of a region exterior to the vehicle, an illumination device, and a controller. The method additionally includes controlling the illumination device to emit light, and capturing a first image, via the sensor, with the illumination device emitting light. The method also includes controlling the illumination device to discontinue emitting light, and capturing a second image, via the sensor, with the illumination device not emitting light. The method further includes automatically calculating, via the controller, a difference image between the first image and the second image, automatically identifying, via the controller, objects present in the difference image, and automatically controlling the actuator, via the controller, in response to objects present in the difference image.

In an exemplary embodiment, the method additionally includes identifying interference in the difference image via the controller, and, in response to identifying interference, changing a coding scheme associated with the illumination device. In such embodiments, the first image may be a first composite image comprising a plurality of images captured with the illumination device emitting light, and the second image may be a second composite image comprising a plurality of images captured with the illumination device not emitting light.

In an exemplary embodiment, the method additionally includes automatically projecting structured light on the identified object. In such embodiments, automatically projecting structured light may include automatically controlling the illumination device via the controller to project the structured light.

A vision system according to the present disclosure includes a sensor configured to capture images of a region, an illumination device configured to selectively illuminate the region, and a controller in communication with the sensor and the illumination device. The controller is configured to control the illumination device to illuminate the region according to a first coding scheme, control the sensor to capture a first image with the illumination device emitting light and a second image with the illumination device not emitting light, calculate a difference image between the first image and the second image, detect interference in the difference image and, in response to detecting interference, to control the illumination device to illuminate the region according to a second coding scheme. The second coding scheme is distinct from the first coding scheme.

In an exemplary embodiment, the first image is a first composite image comprising a plurality of images captured with the illumination device emitting light, and the second image is a second composite image comprising a plurality of images captured with the illumination device not emitting light.

In an exemplary embodiment, the controller is further configured to detect an object present in the difference image, and to control the illumination device to project structured light on the identified object.

In an exemplary embodiment, the illumination device comprises at least one LED.

Embodiments according to the present disclosure provide a number of advantages. For example, the present disclosure provides a system and method reducing disturbance lighting, thereby enhancing the capabilities of vision systems for a automotive vehicles, in turn increasing reliability and customer satisfaction.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a flowchart representation of a method of controlling a vehicle according to an embodiment of the present disclosure;

FIG. 4 is a first example of controlling a vision system according to an embodiment of the present disclosure; and

FIG. 5 is a second example of controlling a vision system according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

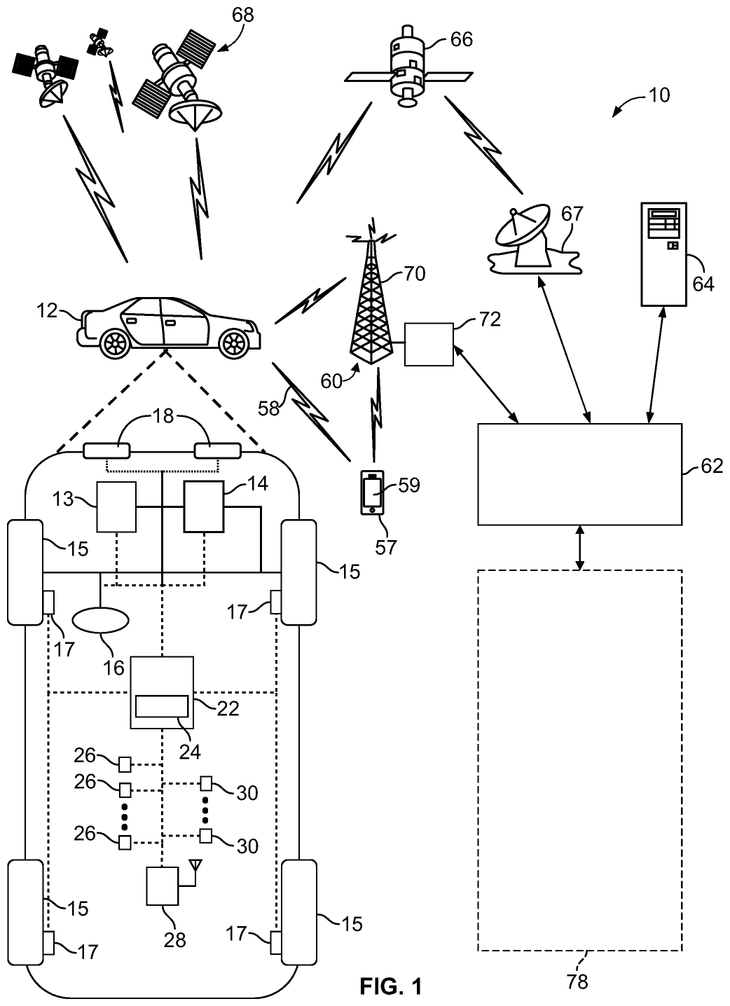

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 further includes at least one illumination device or devices 18 configured to illuminate a region exterior the vehicle 12. While depicted as headlights for illustrative purposes, the illumination devices 18 may take other configurations or be disposed in other locations on the vehicle 12. The illumination devices 18 comprise one or more LEDs or other illumination sources having a variable duty cycle, as will be discussed in further detail below. During a duty cycle, the illumination devices 18 may alternate between an “on” condition in which the illumination devices 18 emit light and an “off” condition in which the illumination devices 18 do not emit light.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, wheel brakes 17, and illumination devices 18 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Three automation system. A Level Three system indicates “Conditional Automation”, referring to the driving mode-specific performance by an automated driving system of all aspects of the dynamic driving task with the expectation that the human driver will respond appropriately to a request to intervene.

Other embodiments according to the present disclosure may be implemented in conjunction with so-called Level One or Level Two automation systems. A Level One system indicates “driver assistance”, referring to the driving mode-specific execution by a driver assistance system of either steering or acceleration using information about the driving environment and with the expectation that the human driver performs all remaining aspects of the dynamic driving task. A Level Two system indicates “Partial Automation”, referring to the driving mode-specific execution by one or more driver assistance systems of both steering and acceleration using information about the driving environment and with the expectation that the human driver performs all remaining aspects of the dynamic driving task.

Still other embodiments according to the present disclosure may also be implemented in conjunction with so-called Level Four or Level Five automation systems. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

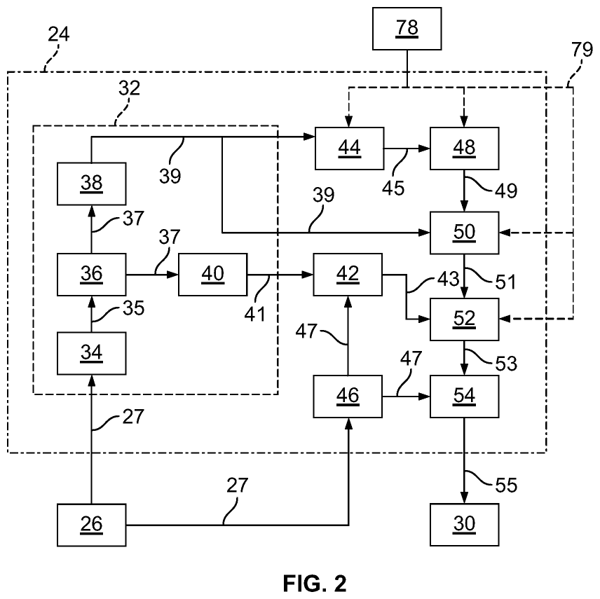

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

As discussed above, the sensors 26 may comprise optical cameras or other sensors configured to detect light in the visible spectrum. However, such sensors are susceptible to noise in the form of disturbance light from sources in the vicinity of the vehicle, e.g. headlights of other oncoming vehicles. Such disturbance lights may wash out otherwise-detectable features proximate the vehicle 12.

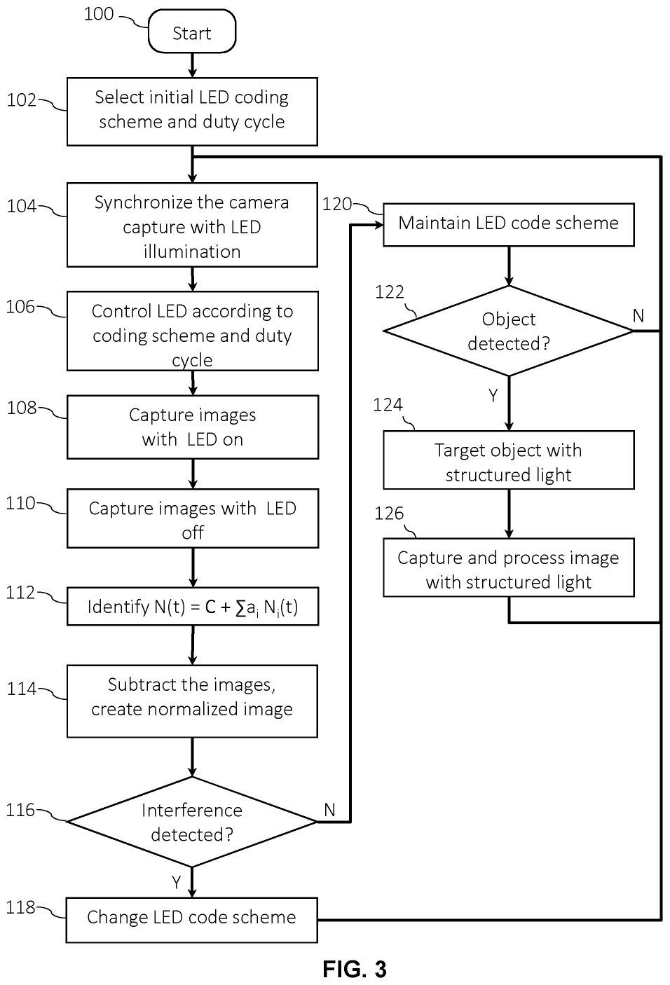

Referring now to FIG. 3, a method of controlling a vision system of a vehicle is illustrated in flowchart form. The algorithm begins at block 100.

An initial LED coding scheme and duty cycle for the illumination devices 18 are selected, as illustrated at block 102. As discussed above, the illumination devices 18 comprise one or more LEDs or other illumination sources having a variable duty cycle. The duty cycle refers to the fraction of time during a given period during which the illumination devices 18 are on. The duty cycle affects the perceived brightness of the illumination devices 18. The coding scheme, meanwhile, refers to the pattern in which the illumination devices 18 are turned on and off during the given period. The period may include a plurality of alternating on segments and off segments of similar or differing lengths. A common duty cycle may thereby be achieved via a plurality of distinct coding schemes.

A sensor sampling rate is synchronized with the coding scheme, as illustrated at block 104. In an exemplary embodiment, this comprises controlling the sampling rate of an optical camera, e.g. one of the sensors 26, to synchronize with the coding scheme. Synchronization refers to adjusting the sampling rate of the sensor 26 such that, during each period of the duty cycle of the illumination device, at least one sample is captured during each on segment and each off segment of the selected coding scheme for the illumination device 18.

The illumination device is then controlled according to the selected coding scheme and duty cycle, as illustrated at block 106, e.g. turned on and off in a periodic manner according to the coding scheme.

One or more images are captured with the illumination device turned on, as illustrated at block 108.

One or more images are captured with the illumination device turned off, as illustrated at block 110.

A noise modeling step is performed, as illustrated at block 112. The noise model may be expressed as:

N(t)=C+ΣαᵢNᵢ(t)

where N(t) is the total noise at time t, comprising a constant caused by non-periodic light sources such as incandescent lights, and a sum of the noise caused by periodic light sources such as LED lights at time t. Various known frequency analysis techniques may be performed to isolate the frequency components of the periodic light noise sources.

A difference image is calculated based on a difference between the image(s) with the illumination device turned on and the image(s) with the illumination device turned off, as illustrated at block 114. The difference image may be calculated using various known techniques for determining differences between two images. In an exemplary embodiment, a first composite image is formed based on multiple images captured with the illumination device turned on, a second composite image is formed based on multiple images captured with the illumination device turned off, and the difference image is calculated between the first composite image and the second composite image. Such an embodiment may be useful for reducing periodic disturbance light, as will be discussed below with respect to FIG. 5. The difference image is then normalized to enhance details that are visible only with the illumination devices turned on, i.e. removing the disturbance light.

A determination is then made of whether interference is detected, as illustrated at operation 116. As an example, interference may be detected if one or more frequency components of the periodic light sources identified in block 112 align with the coding scheme for the illumination source.

In response to the determination of operation 116 being positive, i.e. interference is detected, then an alternate coding scheme for the illumination devices is selected, as illustrated at block 118. Control then returns to block 104. The coding scheme may thereby be changed, while maintaining the duty cycle, until no interference is detected.

In response to the determination of operation 116 being negative, i.e. no interference being detected, then the current coding scheme is maintained, as illustrated at block 120.

A determination is then made of whether an object of interest is detected in the difference image, as illustrated at operation 122. In an exemplary embodiment, this determination is performed by the classification and segmentation module 36.

In response to the determination of operation 122 being negative, control returns to block 104. The system thereby continues according to the current LED coding scheme unless and until interference is detected or an object is detected.

In response to the determination of operation 124 being positive, the detected object is targeted with structured light, as illustrated at block 124. Structured light refers to the projection of a known pattern, e.g. a grid, onto a scene to facilitate 3-dimensional reconstruction of the scene. In an exemplary embodiment, the structured light is projected by the illumination devices 18; however, in alternate embodiments the structured light may be projected by other sources. In an exemplary embodiment, the structured light is projected at the current coding scheme and duty cycle.

An image is captured with the structured light projected, and the image is processed, as illustrated at block 126. In an exemplary embodiment, the processing comprises an image differentiation step generally similar to that discussed at block 114 to reduce or eliminate disturbance light. The resulting image may subsequently be used by the ADS 124, e.g. as an input to the sensor fusion and preprocessing module 34. Control then returns to block 104.

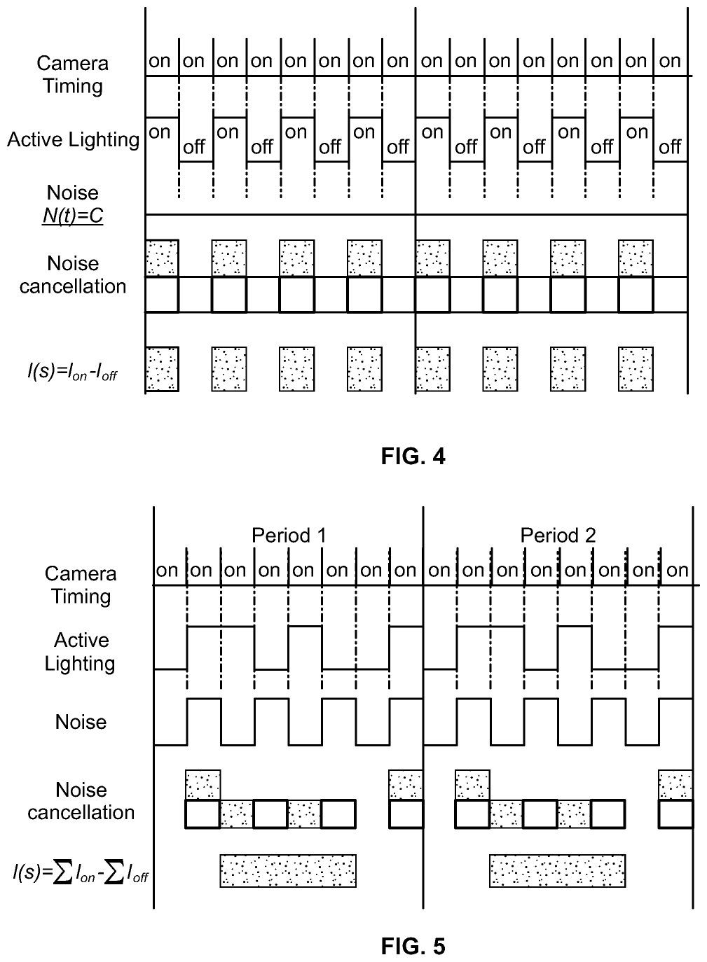

Referring now to FIG. 4, a first illustrative example of controlling the illumination device 18 and sensor 26 is shown. In this example, a constant disturbance light is present. In this example, a simple coding scheme of alternating on and off segments of approximately equal length may be used to identify and reduce the disturbance light as discussed above with respect to FIG. 3.

Referring now to FIG. 5, a second illustrative example of controlling the illumination device 18 and sensor 26 is shown. In this example a periodic disturbance light, e.g. an LED light source, is present. In this example, a more complex coding scheme comprising on and off segments of differing lengths is used. The disturbance light may thus be reduced by subtracting a composite of images captured with the illumination device off from a composite of images captured with the illumination device on.

As may be seen the present disclosure provides a system and method for reducing disturbance lighting, thereby enhancing the capabilities of vision systems for a automotive vehicles, in turn increasing reliability and customer satisfaction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
an actuator configured to control vehicle steering, acceleration, speed, or shifting;
a sensor configured to capture images of a region exterior to the vehicle;
an illumination device coupled to the vehicle; and
a controller in communication with the actuator, the sensor, and the illumination device, the controller being configured to, during a drive cycle, control the sensor to capture a first image with the illumination device emitting light and a second image with the illumination device not emitting light, calculate a difference image between the first image and the second image, control the actuator in a first mode in response to an object being detected in the difference image, and control the actuator in a second mode in response to no object being detected in the difference image.

2. The automotive vehicle of claim 1, wherein the controller is further configured to detect interference in the difference image and, in response to detecting interference, to change a coding scheme of the illumination device.

3. The automotive vehicle of claim 2, wherein the first image is a first composite image comprising a plurality of images captured with the illumination device emitting light, and wherein the second image is a second composite image comprising a plurality of images captured with the illumination device not emitting light.

4. The automotive vehicle of claim 1, wherein the first mode comprises a projection of structured light on the identified object.

5. The automotive vehicle of claim 4, wherein the structured light is projected via the illumination device.

6. The automotive vehicle of claim 1, wherein the illumination device comprises at least one LED.

7. A method of controlling a vehicle, comprising:
providing the vehicle with an actuator configured to control vehicle steering, acceleration, speed, or shifting, a sensor configured to capture images of a region exterior to the vehicle, an illumination device, and a controller;
controlling the illumination device to emit light;
capturing a first image, via the sensor, with the illumination device emitting light;
controlling the illumination device to discontinue emitting light;
capturing a second image, via the sensor, with the illumination device not emitting light;
automatically calculating, via the controller, a difference image between the first image and the second image;
automatically identifying, via the controller, objects present in the difference image; and
automatically controlling the actuator, via the controller, in response to objects present in the difference image.

8. The method of claim 7, further comprising identifying interference in the difference image via the controller, and, in response to identifying interference, changing a coding scheme associated with the illumination device.

9. The method of claim 8, wherein the first image is a first composite image comprising a plurality of images captured with the illumination device emitting light, and wherein the second image is a second composite image comprising a plurality of images captured with the illumination device not emitting light.

10. The method of claim 7, further comprising automatically projecting structured light on the identified object.

11. The method of claim 10, wherein automatically projecting structured light comprises automatically controlling the illumination device via the controller to project the structured light.

12. A vision system comprising:
a sensor configured to capture images of a region;
an illumination device configured to selectively illuminate the region; and
a controller in communication with the sensor and the illumination device, the controller being configured to control the illumination device to illuminate the region according to a first coding scheme, control the sensor to capture a first image with the illumination device emitting light and a second image with the illumination device not emitting light, calculate a difference image between the first image and the second image, detect interference in the difference image and, in response to detecting interference, to control the illumination device to illuminate the region according to a second coding scheme, distinct from the first coding scheme.

13. The vision system of claim 12, wherein the first image is a first composite image comprising a plurality of images captured with the illumination device emitting light, and wherein the second image is a second composite image comprising a plurality of images captured with the illumination device not emitting light.

14. The vision system of claim 12, wherein the controller is further configured to detect an object present in the difference image, and to control the illumination device to project structured light on the identified object.

15. The vision system of claim 12, wherein the illumination device comprises at least one LED.
